(19) United States
(12) Patent Application Publication
(10) Pub. No.: US 2014/0269814 A1
(43) Pub. Date: Sep. 18, 2014

(54) INTEGRITY VERIFICATION OF IR DETECTORS FOR A RAIL VEHICLE

(71) Applicant: Progress Rail Inspection & Information Systems S.r.I., Bologna (IT)

(72) Inventors: Alessandro Agostini, Firenze (IT); Marco Tili, Vaiano (IT); Mario Viggiani, Strada in Chianti (IT); Andrea Ricci, Firenze (IT)

(73) Assignee: Progress Rail Inspection & Information Systems S.r.I., Bologna (IT)

(21) Appl. No.: 14/189,048

(22) Filed: Feb. 25, 2014

(30) Foreign Application Priority Data
Mar. 15, 2013 (EP) 13159510.0

(51) Int. Cl. G01K 15/00; G01J 5/02

(52) U.S. Cl. CPC G01K 15/007; G01J 5/026
USPC 374/2

(57) ABSTRACT

An apparatus for integrity verification of an IR detector that is configured to detect a temperature of an IR emission from an undercarriage component is described. The apparatus includes an IR emitter which emits an IR signal at a reference temperature and the IR signal is directed at the IR detector. A controller is connected to the IR detector and the IR emitter. The controller is configured to compare the reference temperature of the IR signal and the detected temperature of the IR signal to determine the integrity of the IR detector.

### CROSS REFERENCE TO RELATED APPLICATION

This application claims priority to European patent application number EP 13159510.0 filed on Mar. 15, 2013.

### TECHNICAL FIELD

This disclosure generally relates to the field of rail transportation, and to the field of infrared detectors for undercarriage components of trains. This disclosure relates, more particularly, to the testing of infrared detectors for undercarriage components of trains.

### BACKGROUND

Safe and reliable operation of a railroad system may be dependent upon the integrity of the undercarriage components of rail vehicles. Worn or damaged undercarriage components, such as train wheel or train wheel bearings, may increase the rolling friction of an axle thereby requiring an increase of power to move the train.

In addition, worn or damaged undercarriage components may cause excessive wear to the train axle and, in the case of failure of the bearing, may even cause the axle to lock up by preventing rotation of the wheel and thus resulting in a potential fire hazard due to the heat build up and potential sparking caused by friction of the locked wheel scraping along the rail.

Bearing temperatures may be detected by sensing a temperature of the wheel bearing indirectly through a bearing box surrounding the wheel bearing on the rail vehicle. For example, infrared radiation (IR) detectors may be mounted along a rail to detect IR energy emitted by an outer wheel bearing of passing rail vehicles. The emissions of IR energy may be indicative of a temperature of the wheel bearing.

The bearing temperatures may be detected by IR detectors that comprise sensing elements aimed at different parts of a target scanning area of the rail vehicle undercarriage component. The IR data obtained may be used to generate respective scanning signature waveform data corresponding to each different region. The IR detectors may be oriented so that at least one of the sensing elements receives unobstructed infrared emissions from the undercarriage component passing over the IR detector.

A control circuit for the IR detectors may cause an alarm to be raised if the IR data is indicative of temperature that is higher than a pre-set temperature threshold.

However, the IR detectors may have failures. A failure may be incorrect data being generated based on the IR emissions.

The present disclosure is directed, at least in part, to improving or overcoming one or more aspects of the prior art system.

### BRIEF SUMMARY OF THE INVENTION

In a first aspect, the present disclosure describes an apparatus for integrity verification of an IR detector configured to detect a temperature of an IR emission from an undercarriage component in a detection path. The apparatus comprises an IR emitter configured to emit an IR signal at a reference temperature wherein the IR emitter is positioned such that the IR signal is directed at the IR detector; and a controller connected to the IR detector and the IR emitter wherein the controller is configured to compare the reference temperature of the IR signal and the detected temperature of the IR signal to determine the integrity of the IR detector.

In a second aspect, the present disclosure describes a method for integrity verification of an IR detector configured to detect a temperature of an IR emission from an undercarriage component in a detection path. The method comprises the steps of detecting temperature of the IR emission during passage of a rail vehicle; activating the IR emitter to emit an IR signal at a reference temperature, the IR emitter being positioned such that the IR signal is directed at the IR detector; detecting temperature of the IR signal; and comparing the reference temperature of the IR signal and the detected temperature of the IR signal to determine the integrity of the IR detector.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a schematic diagram of an apparatus for integrity verification of an IR detector for a rail vehicle undercarriage component in a first embodiment according to the present disclosure;

FIG. 2 is a schematic diagram of an apparatus for integrity verification of an IR detector for a rail vehicle undercarriage component in a second embodiment according to the present disclosure;

FIG. 3 is a schematic diagram of an apparatus for integrity verification of an IR detector for a rail vehicle undercarriage component in a third embodiment according to the present disclosure; and

FIG. 4 is a schematic diagram of an apparatus for integrity verification of an IR detector for a rail vehicle undercarriage component in a fourth embodiment according to the present disclosure.

### DETAILED DESCRIPTION

This disclosure generally relates to an apparatus for verifying the integrity of an IR detector that is provided to detect the temperature of rail vehicle undercarriage components. Integrity verification may involve testing the accuracy and reliability of the IR detector by providing a reference IR signal and comparing the detected temperature of the IR signal and the temperature of the IR signal.

With reference to FIG. 1, the apparatus 10 may verify the integrity of an IR detector 12. The apparatus 10 may be located at a rail track 40 for performing an integrity verification test on the IR detector 12 that may be positioned in a rail bed of the track 40, such as within a cross tie or a sleeper.

The IR detector 12 may be positioned to receive IR emissions 17 from a rail vehicle undercarriage passing over the IR detector 12. The IR detector 12 may have a series of sensing elements 13. A rail undercarriage may comprise undercarriage components 16, for example wheels, wheel bearings and axles. IR detector 12 may be orientated so as to receive IR emissions 17 from the target undercarriage component 16. IR emissions 17 may be obtained as the undercarriage component 16 passes over the IR detector 12. IR emissions 17 may be received by the sensing elements 13.

IR emissions 17 may traverse through an aperture 18 that is provided in the body 20 of the IR detector 12. The aperture 18 may be opened or closed through a shutter 22. A slot 24 may be provided in a portion of body 20 adjacent to the aperture 18 to receive the shutter 22. The aperture 18 may be opened when the shutter 22 is moved into the slot 24. The aperture 18 may be closed when the shutter 22 is moved from the slot 24 into the aperture 18.

The actuation of the shutter 22 to move into and out from the slot 24 may be linked to the passage of a rail vehicle. The passage of a rail vehicle may result in the actuation of the shutter 22 to move into the slot 24 so as to open the aperture 18 for entry of the IR emissions 17. In the absence of a passing rail vehicle the shutter 22 may be actuated to move out from the slot 24 so as to close the aperture 18.

With reference to FIGS. 1 and 3, the IR emissions 17 may be diverted after passing into the body 20 through the aperture 18. IR emissions 17 may be diverted to the IR detector 12 by a reflector 28. In an embodiment, the reflector 28 may be a mirror. The reflecting plane of the reflector 28 may be inclined relative to the aperture 18 at an angle of about 45°. In an embodiment, the IR detector 12 may be positioned in the body 20 so as to receive IR emissions 17 passing directly through the aperture 18.

With reference to FIGS. 1, 2, 3 and 4, the IR emissions 17 may be focused by a lens 30 prior to being received by the IR detector 12. Lens 30 may have a focal length F.

With reference to FIGS. 2 and 4, the IR detector 12 may have a detection path 14. The detection path 14 may be defined as the optical path from the zone within which the undercarriage component 16 may pass. IR emission 17 may travel along the detection path 14 from the undercarriage component 16 to the IR detector 12. The IR detector 12 may be configured to detect a temperature of an IR emission 17 from the undercarriage component 16 that is within the detection path 14. The detection path 14 may traverse through the aperture 18. With reference to FIGS. 1 and 3, the detection path 14 may include a diversion with a reflector 28.

The detection path 14 may have a distance of between 600 mm to 800 mm from the IR detector 12. The detection path 14 may have a distance of between 600 mm to 800 mm from the IR detector 12 to the undercarriage component 16. In an embodiment, the detection path 14 may have a distance of 700 mm from the IR detector. In an embodiment, the detection path 14 may have a distance of 700 mm from the IR detector 12 to the undercarriage component 16.

In an embodiment, a plurality of IR detectors 12 may be disposed in the rail bed of the track. Each of the IR detectors 12 may have a distinct detection path 14. The IR detectors 12 may each be orientated to scan various undercarriage components 16.

The apparatus 10 may be positioned away from the passage of the rail vehicle. The passage of the rail vehicle may be defined as the spatial course of the rail vehicle travelling on the track. The passage of the rail vehicle may also be defined as the movement of the rail vehicle travelling on the track. The apparatus 10 may be positioned adjacent to the IR detector 12.

With reference to FIGS. 1, 2, 3 and 4, the apparatus 10 may comprise an IR emitter 26. The IR emitter 26 may be configured to emit an IR signal 32. The IR emitter 26 may produce the IR signal 32 as IR electromagnetic emissions. The IR signal 32 may be a continuous infrared beam or high speed infrared flashes. The IR signal 32 may be emitted at a predetermined reference temperature. The IR signal 32 may be emitted at variable temperatures such that IR signals 32 at different reference temperatures may be emitted.

The IR signal 32 may be directed at the IR detector 12 so as to be detected by the IR detector 12. The IR detector 12 may be configured to detect a temperature of the IR signal 32. The integrity of the IR detector 12 may be determined from the detected temperature. The accuracy and reliability of the IR detector 12 may be positively determined when the detected temperature is equal to the reference temperature at which the IR signal 32 was emitted or substantially equal to the temperature at which the IR signal 32 was emitted. The accuracy and reliability of the IR detector 12 may be negatively determined when the detected temperature is not equal to the reference temperature at which the IR signal 32 was emitted or not substantially equal to the temperature at which the IR signal 32 was emitted.

The IR emitter 26 may be positioned such that the IR signal 32 is directed at the IR detector 12. The IR emitter 26 may be positioned external to the detection path 14. IR emitter 26 may be orientated such that the IR signal 32 is directed at the IR detector 12.

With reference to FIGS. 1 and 2, the IR emitter 26 may be positioned in the detection path 14 of the IR detector 12. With reference to FIG. 1, IR emitter 26 may be positioned such that the IR signal 32 is directed at the IR detector 12 through lens 30. With reference to FIG. 2, IR emitter 26 may be positioned such that the IR signal 32 is not directed at the IR detector 12. The IR signal 32 may be reflected by the reflector 28 so as to be directed at the IR detector 12 through lens 30.

With reference to FIGS. 3 and 4, IR emitter 26 may be positioned external to the detection path 14. A reflector system comprising the reflector 28 and an IR signal reflector 29 may be used to direct the IR signal 32 to the detection path 14. The IR signal 32 may be directed transverse to the IR emissions 17. IR signal reflector 29 may be positioned to reflect the IR signal 32 towards reflector 28. IR signal may be subsequently reflected to the IR detector 12 through lens 30. With reference to FIG. 3, the IR signal reflector 29 may be positioned external to the detection path 14. With reference to FIG. 4, the IR signal reflector 29 may be positioned in to the detection path 14. The IR signal reflector 29 may be of a size so that only a small portion of the IR emission 17 from the undercarriage component 16 is obstructed.

In an embodiment, IR emitter 26 may be positioned external to the detection path 14 and the reflector system comprising the IR signal reflector 29 may be used to direct the IR signal 32 to the detection path 14. IR signal reflector 29 may be positioned to reflect the IR signal 32 towards the IR detector 12 through lens 30. The IR signal reflector 29 may be mounted so as to be supported in or external to the detection path 14. In an embodiment, IR signal reflector 29 may be coupled to the IR emitter 26 through a mounting bracket.

With reference to FIG. 3, the IR signal reflector 29 may be positioned external to the detection path 14. With reference to FIG. 4, the IR signal reflector 29 may be positioned in the detection path 14. The IR signal reflector 29 may be of a size so that only a small portion of the IR emission 17 from the undercarriage component 16 is obstructed. The IR emitter 26 may be mounted so as to be supported in the detection path 14. In an embodiment, IR emitter 26 may be mounted to the IR detector 12 so as to be supported in the detection path 14.

The IR emitter 26 may be mounted externally to the body 20 and aligned with the aperture 18. IR emitter 26 may be mounted externally to body 20 through a mechanical support. IR emitter 26 may face the aperture 18 such that the emitted IR signal 32 may pass through the aperture 18 into the body 20. Emitted IR signal 32 may pass into the body 20 when the aperture 18 is open. Emitted IR signal 32 may not pass into the body 29 when the aperture 18 is closed by the shutter 22.

IR emitter 26 may be externally mounted so as to be centrally aligned relative the aperture 18. IR emitter 26 may be vertically aligned with the aperture 18. In an embodiment, IR emitter 26 may be externally mounted off center relative to the aperture 18. IR emitter 26 may be externally mounted so as to be aligned marginally relative to the aperture 18. The term marginally may be defined as between the center and the edge of an object. IR emitter 26 may be vertically aligned with the aperture 18. In a further embodiment, IR emitter 26 may be externally mounted spaced from the plane of the aperture 18.

In an embodiment, the IR emitter 26 may be mounted internally to the body 20. IR emitter 26 may be mounted externally to body 20 through a mechanical support. The emitted IR signal 32 does not pass through the aperture 18 to enter the body 20. Entry of emitted IR signal 32 into the body 20 may not be dependent on the aperture 18 being opened.

IR emitter 26 may be internally mounted so as to be centrally aligned relative the aperture 18. IR emitter 26 may be vertically aligned with the aperture 18. In an embodiment, IR emitter 26 may be internally mounted off center relative to the aperture 18. IR emitter 26 may be internally mounted so as to be aligned marginally relative to the aperture 18. IR emitter 26 may be vertically aligned with the aperture 18. In a further embodiment, IR emitter 26 may be internally mounted spaced from the plane of the aperture 18.

The IR emitter 26 may occupy a small portion of the detection path 14. IR emitter 26 may be selected so that only a small portion of the IR emission 17 from the undercarriage component 16 is obstructed. IR emitter 26 may have a diameter of approximately 3 mm IR emitter 26 may be a mid IR diode.

In an embodiment, a thermoelectric cooler may be provided to maintain the emitted IR signal 32 stable. The thermoelectric cooler may be coupled to the IR emitter 26. The encumbrance of the IR emitter 26 may be increased with the presence of the thermoelectric cooler. The IR emitter 26 coupled with the thermoelectric cooler may be positioned external to the detection path 14.

Lens 30 may be selected to focus the IR signal 32 onto the IR detector 12. Lens 30 may be positioned between the aperture 18 and the IR detector 12. In an embodiment, lens 30 may be positioned between the reflector 28 and the IR detector 12.

With reference to FIG. 3, the lens 30 may have a characteristic that permits the IR signal 32 to be focused on one of a range of points of the IR detector 12. Lens 30 may have an aberration when the IR signal 32 is off the optical axis and passes through the lens 30 at an angle to the optical the IR signal 32 may be focused on the IR detector 12. Lens 30 may have an aberration such that when the IR signal 32 is off the optical axis and passes through the lens 30 at an angle to the optical, the IR signal 32 may be focused on one of a range of points of the IR detector 12. With reference to FIG. 3, the IR signal 32 exiting from point A on lens 30 may be focused between points B and C.

IR signal 32 passing through the centre of the lens 30 with focal length f and at an angle θ is focused at a point with distance f tan θ from the optical axis. IR signal 32 passing through the outer margins of the lens 30 is focused at different points, either further from the optical axis or closer to the optical axis.

The foregoing description of the lens 30 is not limited to the embodiment of FIG. 3. The lens 30 having the aberration may also be used in embodiments of FIGS. 1 and 2 and other embodiments as herein disclosed. As regards to the embodiment of FIG. 1, the IR emitter 26 may be moved to be off the optical axis of the lens 30. The IR signal 32 may be off the optical axis and passing through the outer margin of the lens 30 at an angle to the optical axis, the IR signal 32 may be focused on one of a range of points of the IR detector 12. As regards the embodiment of FIG. 2, the IR emitter 26 may be positioned off such that the signal reflected by the reflector 28 is the optical axis of the lens 30. The reflected IR signal 32 may be off the optical axis and passing through the outer margin of the lens 30 at an angle to the optical axis, the reflected IR signal 32 may be focussed onto one of a range of points of the IR detector 12.

IR emitter 26 may be disposed adjacent to the IR detector 12. IR emitter 26 may be vertically adjacent relative to the IR detector 12 IR emitter 26 may be positioned at a distance between 300 mm to 150 mm from the IR detector 12. In an embodiment, IR emitter 26 may be positioned at a distance of 200 mm from the IR detector 12

In an embodiment, the position of the IR emitter 26 may be determined by the lens 30. IR emitter 26 may be disposed adjacent to lens 30.

The IR emitter 26 may be aligned with lens 30 and spaced from the center thereof. IR emitter 26 may be positioned off the optical axis of the lens 30. IR emitter 26 may emit an IR signal 32 that passes between the edge and the center of lens 30. The distance of the IR emitter 26 from the lens may be determined from the focal length of the lens. IR emitter 26 may be positioned between 1× to 10× of the focal length of lens 30.

The IR emitter 26 may be disposed alignment with the center of lens 30. IR emitter 26 may be positioned in alignment with the optical axis of the lens 30. IR emitter 26 may emit an IR signal 32 that passes through the center of lens 30.

In an embodiment, a plurality of IR emitters 26 may be disposed in each of the detection paths 14 of the plurality of IR detectors. Each of the IR detectors 12 may have a distinct detection path 14. Each of the IR emitters 26 may be orientated to direct the IR signal at the respective IR detector 12.

The apparatus 10 may comprise a controller 36 connected to a control circuit 34. The control circuit 34 may connect the IR emitter 26 to the controller 36. In an embodiment, the control circuit 34 may connect the plurality of IR emitters 26 to the controller 36. The control circuit 34 may connect the IR detector 12 to the controller 36. In an embodiment, the control circuit 34 may connect the plurality of IR detectors 12 to the controller 36.

The controller 36 may control the IR emitter 26 and the IR detector 12 through the control circuit 34. Controller 36 may obtain thermal readings from the IR detector 12. The controller 36 may activate the IR emitter 26 to emit the IR signal 32. Controller 36 may be connected to the body 20 so as to control the operation of the shutter 22.

The apparatus 10 may further comprise a wheel sensor 38 that is connected to the controller 36 or to the control circuit 34. The wheel sensor 38 may be activated by a passing rail vehicle. The activation of the wheel sensor 38 may effect downstream activation of the IR detector 12 and the IR emitter 26 through the controller 36 or the control circuit 34. The actuation of the shutter 22 may be connected to the passage of the rail vehicle through the controller 36 or the control circuit 34. In an embodiment, the apparatus 10 may comprise a plurality of wheel sensors 38 that are each connected to the controller 36 or to the control circuit 34.

A method for integrity verification of the IR detector 12 which is configured to detect a temperature of IR emissions 17 from an undercarriage component 16 in a detection path 14 may include the following steps.

Detecting temperature of the IR emission 17 from the undercarriage component 16 during passage of the rail vehicle. IR emissions 17 from the undercarriage component 16 may be received by the IR detector 12. Thermal reading of the detected temperature may be sent to the controller 36.

Activating the IR emitter 26 to emit an IR signal 32 at a reference temperature, the IR emitter 26 being positioned in the detection path 14 such that the IR signal 32 is directed at the IR detector 12. The controller 36 may activate the IR emitter 26 to emit the IR signal at the reference temperature. The IR signal 32 may be sent to the IR detector 12.

Detecting temperature of the IR signal 32 of an IR emitter 26. Thermal reading of the detected temperature may be sent to the controller 36. IR signal 32 from the IR emitter 26 may be received by the IR detector 12. Thermal reading of the detected temperature may be sent to the controller 36.

Comparing the reference temperature of the IR signal 32 and the detected temperature of the IR signal 32 to determine the integrity of the IR detector 12. The controller 36 may compare the thermal reading IR signal 32 to the reference temperature at which the IR signal was emitted.

A mismatch in the reference temperature and the detected temperature may result in an error signal. The controller 36 may check if an alarm has been raised when the detected temperature is not equal to the reference temperature at which the IR signal 32 was emitted or not substantially equal to the temperature at which the IR signal 32 was emitted. An error signal may be sent if an alarm is not raised when the detected temperature is not equal to the reference temperature at which the IR signal 32 was emitted or not substantially equal to the temperature at which the IR signal 32 was emitted.

The step of detecting the temperature of the IR emission 17 may precede the step of activating the IR emitter 26 to emit an IR signal 32 and the step of detecting the temperature of the IR signal 32. The step of activating the IR emitter 26 to emit an IR signal 32 and the step of detecting the temperature of the IR signal 32 may precede the step of detecting the temperature of the IR emission 17. The integrity of the IR detector 12 may be determined from the detected temperature.

The method for integrity verification of the IR detector 12 may further comprise the step of determining the accuracy of the detected temperature of the IR emission 17.

The accuracy and reliability of the IR detector 12 may be positively determined when the detected temperature of the IR signal 32 is equal to the reference temperature at which the IR signal 32 was emitted or substantially equal to the temperature at which the IR signal 32 was emitted.

The detected temperature of the IR emission 17 may be determined accurate when the reference temperature of the IR signal 32 is equal to the detected temperature of the IR signal 32. The detected temperature of the IR emission 17 may be determined accurate when the reference temperature of the IR signal 32 is substantially equal to the detected temperature of the IR signal 32.

The accuracy and reliability of the IR detector 12 may be negatively determined when the detected temperature of the IR signal 32 is not the reference temperature at which the IR signal 32 was emitted or not substantially equal to the temperature at which the IR signal 32 was emitted.

The detected temperature of the IR emission 17 may be determined inaccurate when the reference temperature of the IR signal 32 is not equal to the detected temperature of the IR signal 32. The detected temperature of the IR emission 17 may be determined inaccurate when the reference temperature of the IR signal 32 is not substantially equal to the detected temperature of the IR signal 32.

The method for integrity verification of the IR detector 12 may further comprise the step of activating a wheel sensor 38. The step of activating the wheel sensor 38 may precede the steps of detecting the temperature of the IR emission 17, activating the IR emitter 26 to emit an IR signal 32 and detecting the temperature of the IR signal 32.

The controller 36 may monitor the wheel sensor 38. Signals from the wheel sensor 38 may be sent to the controller 36. The controller 36 may activate the IR detector 12 and the IR emitter 26. The IR emitter 26 may be activated to emit the IR signal 32 between the passage of the target undercarriage component 16.

In an embodiment, the controller 36 may record the signals and the information relating to the passage of a rail vehicle. After the rail vehicle has passed, the controller may activate the IR emitter 26 and the IR detector 12. The controller 36 may replicate signals and information from the wheel sensor 38. The replicated signals from the controller 36 may simulate the wheel signals of a passing rail vehicle travelling at a known speed. The replicated wheel signals simulating passage of a rail vehicle may be used to test IR detector 12.

The skilled person would appreciate that foregoing embodiments may be modified or combined to obtain the apparatus 10 or the method of the present disclosure.

### INDUSTRIAL APPLICABILITY

This disclosure describes an apparatus 10 for verifying the integrity of an IR detector 12. The IR detector 12 may be used to obtain infrared IR emission data from rail vehicle undercarriage components 16. The IR data may be obtained by sensing a wheel or a wheel bearing of a rail vehicle passing over the IR detector 12. The IR detectors 12 may be located along a section of a rail track. Abnormal thermal readings may indicate the possibility of overheating undercarriage components 16, such as bearings that are failing or malfunctioning brakes.

For safety reasons the proper operation of the IR detectors 12 is critical. There is a need to periodically check the IR detectors 12 for proper operation, preferably without the need for manual testing and inspection.

The apparatus 10 and method may include an IR emitter 26 which sends an IR signal to the IR detector 12. The IR emitter 26 may be located in the detection path 14 of the IR detector 12. The IR emitter 26 may be activated periodically so as to send an infrared signal to the IR detector 12. The apparatus 10 and method may test the accuracy of the infrared IR emission data obtained by the IR detector 12. A control system may monitor the response of the IR detector 12 to determine if the emitted signal from the IR emitter 26 was received properly. The IR emitter 26 may not interfere with normal operation of the IR detector 12.

The apparatus 10 may perform an integrity test on the IR detector 12 during the passage of rail vehicle. The IR emitter 26 may send an IR signal 32 as the rail vehicle is passing over the IR detectors 12 so that the integrity test may be performed during actual operation of the IR detection system. The IR emitter 26 may send an IR signal 32 between passage of the each rail car over the IR detector 12. The IR emitter 26 may send an IR signal 32 between passage of each undercarriage components 16 over the IR detector 12.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

What is claimed is:

1. An apparatus for integrity verification of an IR detector configured to detect a temperature of an IR emission from an undercarriage component in a detection path, the apparatus comprising:
an IR emitter configured to emit an IR signal at a reference temperature wherein the IR emitter is positioned such that the IR signal is directed at the IR detector; and
a controller connected to the IR detector and the IR emitter wherein the controller is configured to compare the reference temperature of the IR signal and the detected temperature of the IR signal to determine the integrity of the IR detector.

2. The apparatus of claim 1, wherein the IR emitter is positioned in the detection path.

3. The apparatus of claim 1, wherein the IR signal is directed at the IR detector by at least one IR reflector.

4. The apparatus of claim 3, wherein the IR reflector is mounted to the IR emitter.

5. The apparatus of claim 1, wherein the IR emitter is mounted to a body, the body including the IR detector.

6. The apparatus of claim 5, wherein the IR emitter is externally mounted to the body.

7. The apparatus of claim 1, further comprising a lens to focus the IR signal on the IR detector wherein the IR signal is off the optical axis and passes through the lens at an angle to the optical axis.

8. The apparatus of claim 1, wherein the IR emitter is positioned between 300 mm to 150 mm from the IR detector.

9. The apparatus of claim 1, further comprising a wheel sensor connected to the controller.

10. A method for integrity verification of an IR detector configured to detect a temperature of an IR emission from an undercarriage component in a detection path, the method comprising the steps of:
detecting a temperature of the IR emission during passage of a rail vehicle;
activating the IR emitter to emit an IR signal at a reference temperature, the IR emitter being positioned such that the IR signal is directed at the IR detector;
detecting a temperature of the IR signal; and
comparing the reference temperature of the IR signal and the detected temperature of the IR signal to determine the integrity of the IR detector.

11. The method of claim 10, wherein the step of detecting the temperature of the IR emission precedes the step of activating the IR emitter to emit an IR signal and the step of detecting the temperature of the IR signal.

12. The method of claim 10, wherein the step of activating the IR emitter to emit an IR signal and the step of detecting the temperature of the IR signal precedes the step of detecting the temperature of the IR emission.

13. The method of claim 10, further comprising the step of determining an accuracy of the detected temperature of the IR emission.

14. The method of claim 13, wherein the detected temperature of the IR emission is determined to be accurate when the reference temperature of the IR signal is substantially equal to the detected temperature of the IR signal.

15. The method of claim 13, wherein the detected temperature of the IR emission is determined inaccurate when the reference temperature of the IR signal is not substantially equal to the detected temperature of the IR signal.
